(19) United States
(12) Patent Application Publication
(10) Pub. No.: US 2007/0136213 A1
(43) Pub. Date: Jun. 14, 2007

(54) Inline system to detect and show proof of indicia fraud

(75) Inventors: Ronald P. Sansone, Weston, CT (US); Robert A. Cordery, Danbury, CT (US); William Kilmartin, West haven, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/297,598

(22) Filed: Dec. 8, 2005

(51) Int. Cl. G06F 17/00

(52) U.S. Cl. 705/401

(57) ABSTRACT

A method that utilizes a first process that detects if a first printed region that is a fraudulent copy based on information associated with the first printed region; and utilizes the information obtained in the first process to determine in a second process if a second printed region is a fraudulent copy. The information associated with the first printed region may be printer mode, i.e., economic, medium, best, ink cartridge identification number, or numbers, type of ink or inks, resolution of the first and second image, print head angle, resolution pattern, etc. The first process detects fraudulent copies of images more quickly.

### CROSS REFERENCE TO RELATED APPLICATIONS

1. Field of the Invention

The subject invention relates to a method for reading images that contain certain information and, more particularly, to a method that detects when the read images containing certain information are copied.

2. Background of the Invention

Images such as postal indicia have been printed by postage meters to evidence that the appropriate postage has been affixed to the mailpiece. A typical postal indicium includes fixed elements such as city name, state, a graphic, meter serial number, etc., and variable information such as date, postage amount, an encrypted number, etc. Postal indicia have been printed by flat bed printers and rotary printers without encryption and ink jet printers with encryption. Improved photocopying, printing and scanning equipment have made it easier to commit fraud by copying postal indicia.

Currently, ticketing companies are giving purchasers the option of printing their electronic tickets at home, using ordinary paper, a personal computer printer, and an Internet connection. One of the problems in allowing people to print tickets at home is how to ensure that the tickets are not counterfeited. One of the solutions suggested to solve the foregoing problem is to print an encrypted bar code or indicia that contain encryption on the ticket. Unfortunately, a printed ticket on ordinary paper with an encrypted bar code or indicia that contains encryption can be photocopied, and the seller of the ticket will be unable to distinguish between the original, genuine ticket and the photocopied ticket.

### SUMMARY OF THE INVENTION

This invention overcomes the disadvantages of the prior art by providing a method that makes it more difficult to copy an image. The invention distinguishes original prints from copies of a composite image comprising a first region containing a first graphic field and a second region. The invention utilizes a first process that obtains printer information associated with the first region and detects if the first region is a fraudulent copy; and utilizes the printer information obtained in the first process to determine in a second process if the composite image is a fraudulent copy. The printer information associated with the first region may be printer mode, (i.e., economic, medium, best), ink cartridge identification number or numbers, type of ink or inks, resolution of the first and second image, print head angle, or pixel position pattern. The printer information may be provided in print encoded as alphanumeric text, barcode, or other symbology. Alternatively the printer information may be provided through an alternate channel such as a database or electronic communications. The first process more quickly detects fraudulent copies of images. The second process provides more robust copy detection.

The first graphic field is designed to produce a “tell”, a visible known image (a large number of detectable half-tone gray steps) when printed by a personal computer printer. Additionally, the first graphic field will change in appearance when a postal indicia, ticket, document, etc. originally printed by the personal computer printer is reproduced either by scanning and printing or by photocopying.

The digital scanning and photocopying processes are degrading processes that typically reduce the number of detectable half-tone gray steps produced in the copy. These processes also give rise to a pronounced mottle at the zone of smooth transition from light print to dark print that does not exist in the original printed electronic ticket. The loss of some of the gray steps in the first graphic field will indicate to an observer that the reproduced ticket is counterfeit.

The foregoing takes advantage of the fact that the human eye cannot resolve the individual spots in the intermediate gray zone that is somewhere between white and black. The apparent gray level can be modified by changing the size of the spots, the gray-level of the dots or the spacing of the dots, The human eye interprets the intermediate patch of adjacent spots in the gray zone as a particular shade of gray, when, in fact, the adjacent spots in the gray zone are black spots or spots of approximately uniform optical density that vary in size due to process variations introduced by the photocopying and/or scanning processes. The human eye is very sensitive to slight changes of grayness in the intermediate gray zone region. The human eye is thus very sensitive to miniscule variations in the apparent grayness of the patch. Consequently, the human eye will be able to observe that the first graphic field, or tell, on a postal indicia, document or electronic ticket will change in appearance when the postal indicia, document or ticket originally printed by the personal computer printer is either digitally reproduced by scanning or photocopied. Thus, in a first process for detecting fraudulent copies, the human eye or a detector that averages the reflectance over an area containing many printed spots will be able to determine when a copied postal indicia, document or electronic ticket is a fraudulent copy. A low resolution gray-scale camera such as those employed in the postal service for reading envelopes can act as such a detector.

If it is determined in the first process that the postal indicia, document or electronic ticket is a fraudulent copy a decision is made to select the indicium, document or ticket for further investigation in a second process. If on the other hand it is not determined in the first process that the item is a fraudulent copy, then a random decision is made to either allow normal processing of the item or to continue or to select the postal indicia, document or electronic ticket for investigation. The random decision can be based on available resources, value of the item, or other information sources leading to suspicion. Then the scanned printer information associated with the first process is stored for further processing in the second process.

The second process takes advantage of the first process by using the printer information to accurately determine if the second image is a fraudulent copy. In the second region information in a plaintext or encrypted form that represents some facts, such as, date that an indicia was affixed to a mail piece, zip code, etc., is embedded in the second region in a manner that the embedded information will change detectably when the second region is scanned or photocopied. A suitable symbology for use in this invention is disclosed in US Patent Application 20030052178 entitled “Method For Embedding Information In An Image” which has been assigned to the assignee of this invention and is herein incorporated by reference.

A high resolution scan of the first and second regions provides measurements such as the parametrization of the pixel pattern, horizontal and vertical resolution, angle between rows and columns, and offset between even and odd pixels. These measurements are compared with corresponding information obtained in the first process.

Printer information associated with the first process and embedded in the first image can be also embedded in the second image using known watermarking techniques. When the watermark is read using the known techniques for the chosen watermark, the extracted information can be compared to the information extracted from the first process.

An attacker copying the second image faces the difficult combined problem of matching the pixel-scale patterns used to produce the continuous grey image and matching the visually continuous variation of grey level. Alternatively the printer information can be included in a barcode in the second region.

### BRIEF DESCRIPTION OF THE DRAWINGS

FIG. 1A is a drawing of a composite image comprising a first and second region;

FIG. 1B is an expanded view of a portion of first region 25 of FIG. 1A;

FIG. 2 is a drawing of the process flow of this invention;

FIG. 3 is a drawing showing the dots that comprise the first and second regions of FIG. 1A.

### DETAILED DESCRIPTION OF PREFERRED EMBODIMENTS OF THE INVENTION

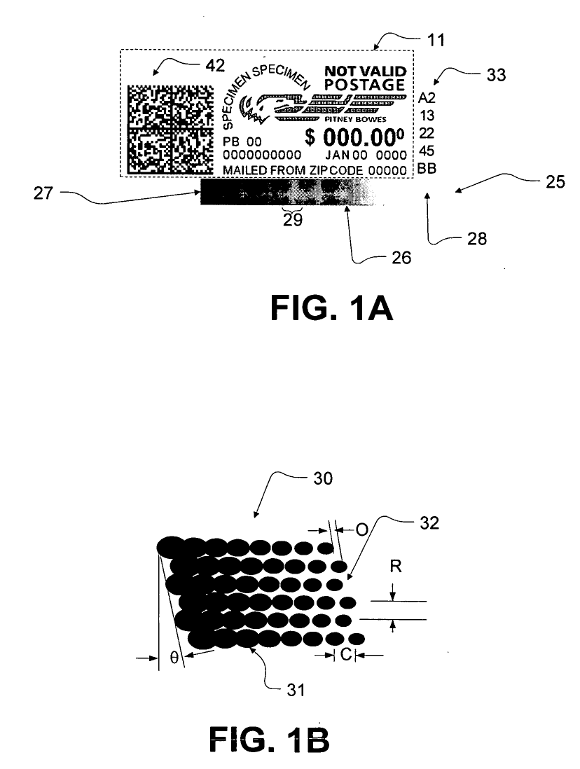

Referring now to the drawings in detail, and more particularly to FIG. 1A, the first printed region 25 includes a graphic field 26 and alphanumeric characters 33. Graphic field 26 is a variable half tone screen print that is designed to appear black at its edge 27, near white at its edge 28, and shades of gray in region 29. An enlarged image of section 29 of graphic field 26 is shown as section 30 in FIG. 1B Section 30 shows the effect of varying the size of black printed spots or dots 31 and white background 32. The percentage of white background 32 decreases from edge 28 to edge 27. In section 30, white background 32 becomes completely surrounded by black spots 31.

FIG. 1B shows an expanded view of a portion of first region 25 shown as section 30 with a varying grey level. The printer has special parameters R, C, O, and θ. R is the spacing between rows. C is the spacing between columns. O parametrizes the local pixel pattern, for example in the figure it represents an odd-even row offset. θ is the angle between the vertical and the angled columns. While R, C, O, and θ represent typical printer parameters, other parameters are possible including, but not limited to, typical spot shape, printer speed, and ink characteristics.

Half-toning is the process used to produce graphic field 26 (FIG. 1A). Half toning is a technique that is used by printers to represent a gray scale image on a bi-level (black and white) page. Half toning breaks up an image into spots of varying sizes to simulate the original image. The eye perceives a shade of gray depending on the percentage of ink coverage. Black and white laser and ink jet computer printers use ink or toner of only a few blackness. Therefore, to produce various shades of gray to reproduce a continuous gray scale image, the image is broken into a series of spots. Varying the spot sizes approximates the shades of gray.

Thus, a group of large spots placed closely together appears black. A group of smaller spots with larger spaces between them produces a pale gray shade. A group of even smaller black spots spaced widely apart would appear almost white. A gray impression can also be produced by varying the spacing of the dots. In the limit of light gray the dots become very far apart, so the effective range of gray levels that can be produced are limited by the resolution of human vision.

Graphic field 26 consists of a continuously varying tone area. A field where the range of tone has been pre-selected to provide a continuum of spots that slowly vary from small white backgrounds with large black spots to small black spots on a white background. Small is defined as being below the resolution limit of the human eye. When printed by a laser or ink jet printer graphic field 26 appears black at its edge 27, near white at its edge 28, and shades of gray in region 29. Graphic field 26 is more fully described in Sansone's U.S. Pat. No. 6,603,568 B1, entitled “System And Method For Issuing Electronic Tickets” which has been assigned to the assignee of this invention and is herein incorporated by reference.

The information 33, which may be encrypted in first region field 25, may be printer mode, i.e., economic, medium, best, ink cartridge identification number, or numbers, type of ink or inks, resolution of the first and second region fields (R,C), print head angle (θ), pixel pattern (O), etc. Information 33 may be used in the second process to more quickly detect fraudulent copies of the second region of the second image. The information 33 may be contained in the first region or the second region. Alternatively, information 33 may be obtained from an external source.

Second printed region 11 contains graphic material, i.e., a postal indicium and descriptive postal textual material. Second printed region 11 may contain other graphic and textual material and may be affixed to a ticket and/or a document, etc. If second printed region 11 contains a postal indicia, image 11 includes graphic material in the form, for example, of an eagle, a dollar amount; the date that second printed region 11 was affixed to a mail piece; the zip code where the mail piece was mailed; the postal meter serial number; a security code in the form of a unique number; and the class of mail. The postal indicium information can be included in second region 11 in alphanumeric text or as a barcode 42.

A two-dimensional bar code 42 represents in coded form textual material contained in second image 11 and other information. The barcode may be of the type known as DataMatrix. Bar code 42 comprises a plurality of black modules 43 and white modules 44. Black modules 43 represent a “zero” and white modules 44 represent a “one”. Information encoded in the barcode may include a dollar amount; the date that second printed region 11 was affixed to a mail piece; the zip code where the mail piece was mailed; the postal meter serial number; a security code in the form of a unique number; and the class of mail. Additionally the information may be encrypted or the barcode may contain a digital signature to prove the authenticity of the information. The manner in which the information contained in bar code 42 is transformed and hidden in the the second region, for example in the vicinity of the eagle graphic is more fully described in Cordery's et al, U.S. patent application Ser. No. 10/087,492, Publication No. 2003 000 2711 A1 entitled “Method for reading information that has been embedded in an image” which has been assigned to the assignee of this invention and is herein incorporated by reference.

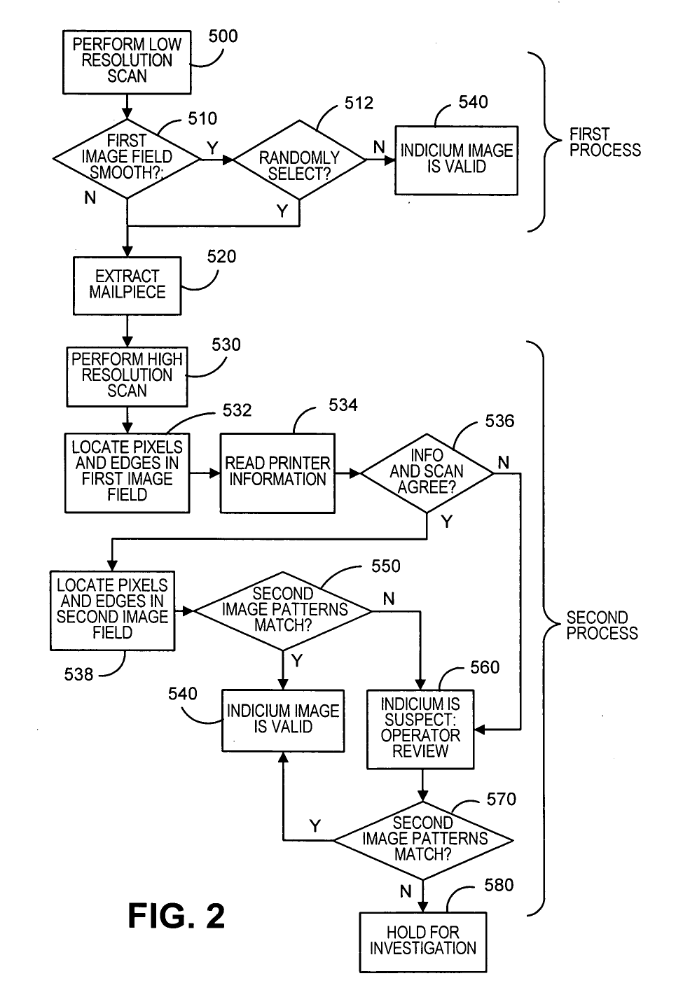

FIG. 2 shows a process flow for verifying the graphic security features. First a low resolution scan 500 is performed. This may be the typical scan of the indicium performed in indicium reading. Alternatively, the scan 500 may be a visual scan by a user of the document or mailpiece such as a postal carrier. A determination is made at 510 from the scanned image whether the grey level variation of the first image region is sufficiently smooth. If the grey level variation is not sufficiently smooth, then the mail piece is selected for forensic analysis in a second process by extracting the mail piece in 520. If the grey level variation is sufficiently smooth, then a determination is made at 512 at random or on any other criteria whether to extract the mail piece at 520 to perform the forensic analysis in the second process. If a decision is not made to perform the forensic analysis of the second step then the image is declared valid at 540 and is processed normally, such as delivering the mail piece.

The second process is a forensic process that begins by performing a high resolution scan of the image at 530. The high resolution image is analyzed at 532 to measure the image properties such as the locations of pixels and edges in the first image field. The printer information 33 is read at 534. A comparison of the measured edge and pixel locations to the printer information is made at 536 to determine if they are consistent. If the measured edge and pixel locations are inconsistent with the printer information, then the indicium is declared suspect at 560. If the measured edge and pixel locations are consistent with the printer information, then the high resolution scan of the second region is processed at 538.

Processing the second image region proceeds at 538, by measuring printed image properties such as the locations of pixels and edges in the second region. If the measured printed image properties match at 550 with the measurements of the first image field and with the printer information then the indicium image is declared to be an original and is processed normally at 540. If the measured printed image properties fail to match with the measurements of the first image field and with the printer information then the indicium image is declared to be suspect. Matching at 550 of the measured printed image properties in the second image field with the printer information and measured locations in the first image field comprises: verifying that the measured values of R, C, O, and θ are consistent with the printer information within experimental error; verifying that the measured values of R, C, O, and θ are consistent with the values measured from the first image field within experimental error; and verifying that the lattice of pixel and edge locations in the second image field is a continuation of the lattice of pixel and edge locations in the first image field. If it is determined at 550 that the indicium is suspect then the indicium is presented at 560 to an operator for review. The operator may decide at 570 to accept the indicium as valid or to hold at 580 the indicium for further investigation.

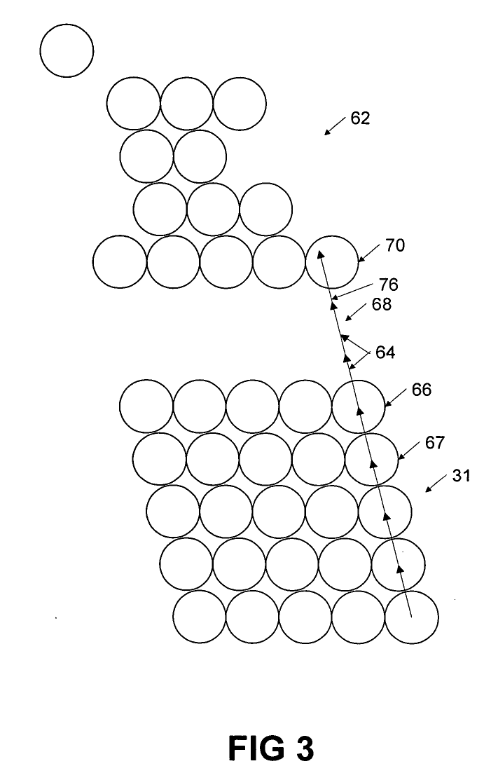

A lattice of dots shown generally at 31 is printed in the first region in FIG. 3. A second lattice of dots shown generally at 62 is printed in the second region (which is shown in FIG. 1A as second printed region 11). The dots are shown in outline only for clarity. Line 68 passes through the centers of dots 66 and 67 in the first region. A set of arrows 64 mark off lengths of line 68 that are equal to the spacing between dots 66 and 67 in the first region. Only two of the arrows are indicated at 64, but all of the arrows on line 68 are included in the set of arrows 64. Line 68 and arrow 76 miss the center of the closest dot in the second region. Dot 70 lies below and to the right of the closest arrow 76 in the set of arrows 64. If the first and second regions were printed at the same time with the same printer, then the center of dot 70 would land on the line 68. A set of equally spaced line arrows 64, are aligned with rows of dots 31 in the second region.

The above specification describes a new and improved method for utilizing a first and second image to determine if the images are fraudulent copies. It is realized that the above description may indicate to those skilled in the art additional ways in which the principles of this invention may be used without departing from the spirit. Therefore, it is intended that this invention be limited only by the scope of the appended claims.

What is claimed is:

1. A method for detecting a copy of a composite image that includes printer information, a first region and a second region so that the first and second regions will change in appearance when the first and second regions are scanned and printed or photocopied, comprising the steps of:
utilizing a first process that obtains the printer information and identifies if the first region is a fraudulent copy; and
utilizing the printer information obtained in the first process to determine in a second process if the composite image is a fraudulent copy.
The method claimed in claim 1, further including the steps of:
measuring image properties of the first region; and
comparing the measured image properties with the printer information to determine if the measured properties are consistent with the printer information.

2. The method claimed in claim 2, wherein the measured image properties are locations of pixels that comprise the first region.

3. The method claimed in claim 2, wherein the measured image properties are edge locations of pixels that comprise the first region.

4. The method claimed in claim 2, further including the steps of:
measuring image properties of the second region; and
comparing the measured image properties of the second region with the printer information and the measured properties of the first region to determine if the composite image is an original image.

5. The method claimed in claim 5, wherein the second measured image properties are locations of pixels that comprise the second region.

6. The method claimed in claim 5, wherein the measured image properties are edge locations of pixels that comprise the second region.

7. The method claimed in claim 1, wherein the second region is a postal indicia image.

8. The method claimed in claim 1, wherein the first and second regions are printed on a medium.

9. The method claimed in claim 1, wherein the information embedded in the first region is a printer mode.

10. The method claimed in claim 1, wherein the information embedded in the first region identifies a ink cartridge or ink cartridges that were used to print the composite images.

11. The method claimed in claim 1, wherein the information embedded in the first region identifies a ink or inks that were used to print the composite.

12. The method claimed in claim 1, wherein the information embedded in the first region identifies an image resolution of the first region.

13. The method claimed in claim 1, wherein the information embedded in the first region identifies an image resolution of the second region.

14. The method claimed in claim 1, wherein the information embedded in the first region identifies the first and second regions print head angle.

15. The method claimed in claim 1, wherein the first region and second region are affixed to a document.

16. The method claimed in claim 1, wherein the first region and second region are affixed to a ticket.
